(19) United States
(12) Patent Application Publication
(10) Pub. No.: US 2016/0157972 A1
(43) Pub. Date: Jun. 9, 2016

(54) DENTAL TRANSFER TEMPLATE

(71) Applicant: Ivoclar Vivadent AG, Schaan (LI)

(72) Inventors: Konrad HAGENBUCH, Haag (CH); Christian FREI, Naturns (IT); Hans-Peter FOSER, Balzers (LI)

(21) Appl. No.: 14/890,987

(22) PCT Filed: Oct. 16, 2014
(86) PCT No.: PCT/EP2014/072275

§ 371 Date: Nov. 13, 2015

(30) Foreign Application Priority Data
Oct. 17, 2013 (EP) 13189179.8
Sep. 11, 2014 (EP) 14184493.6

(51) Int. Cl. A61C 13/36; A61C 13/00

(52) U.S. Cl. CPC A61C 13/1016; A61C 13/0004

(57) ABSTRACT

The invention relates to a dental transfer template arrangement, with a transfer template and a prosthesis base which in particular are both produced by the same CAD/CAM device, wherein both have a large number of recesses for teeth, wherein incisor and/or occlusal areas fit into the recesses of the transfer template and cervical areas of teeth fit into the recesses of the prosthesis base, wherein the teeth are each to be adhesively bonded in the recesses of the prosthesis base, characterized in that a bite barrier (18) of the transfer template (20), which barrier prevents closure of rows of teeth, is provided in the occlusal plane, the thickness of which barrier measures in particular about 2 to 8 mm, and in that, starting from the bite barrier (18), the tooth recesses (21) are open in mutually opposite directions corresponding to upper jaw and lower jaw, in that teeth are held in the recesses (21) of the transfer template (20) and, in particular, the transfer template (20) for the teeth (33, 35) can be used for basal shortening of the teeth, and in that the adhesive surface of each tooth (31, 33, 35, 37) in the prosthesis base (10) has a predefined minimum threshold value, in particular at least 10 mm², preferably at least 18 mm², and particularly preferably at least 25 mm², which threshold value is in particular set in the CAD software of the CAD/CAM device for the production of the prosthesis base.

The invention concerns a dental transfer template arrangement in accordance with the preamble of Claim 1.

With prostheses manufactured with the help of CAD/CAM it is necessary to adhesively bond artificial teeth to a prosthesis base. The artificial teeth may be manufactured both traditionally (industrially) and with the help of CAD/CAM and consist of different materials.

In order to adhesively bond the teeth inside the cavity of a prosthesis base in a permanent fashion, a correct positioning of the respective tooth with relation to the prosthesis base is necessary. In this, each tooth or each group of teeth is to be controlled for correct matching individually and manually, and subsequently to be adhesively bonded in.

For the control, what is referred to as a transfer template has already been suggested. Such a transfer template is a negative form manufactured in particular with the help of CAD/CAM, wherein recesses are provided for bearing the teeth. The teeth and/or groups of teeth are temporarily borne in the recesses of the template, and for adhesively bonding them inside the cavities of the prosthesis base are transferred there. Before/during adhesive bonding, a safe and correct positioning of the teeth inside the cavities of the prosthesis base is made sure with the help of the template.

Such a transfer template may be created by the CAD/CAM device based on scanned and CAD data, which both data are each obtained from a three-dimensional scan of an oral situation of a patient and from a template library inside the CAD software. A corresponding prosthesis base is in particular created by the same CAD/CAM device based in particular on the same scanned data and the CAD data from a prosthesis base library in the CAD software, such that the artificial teeth can be transferred with the help of the transfer template and be positioned and adhesively bonded inside the cavity of the prosthesis base.

Such a dental transfer template is known from WO 2012/155161 A1. In accordance with WO 2012/155161 A1, the prosthesis teeth are brought into a defined position with the help of a transfer template which is referred to as an “auxiliary holding device” there, and are held there.

A further dental transfer template of the kind is known from EP 2 030 590 A1. Each individual prosthesis tooth is temporarily held inside the recess of the transfer template there with the help of wax or a resin. Rod 18 of the transfer template there makes possible a manual orientation and positioning of the teeth inside the cavities of the prosthesis base.

Such and also the other present-day dental transfer templates, however, are only able to position the artificial teeth to the respective prosthesis base either at the upper jaw or at the lower jaw. If prosthetics is necessary at both jaws of patients, it is only possible to use two transfer templates (one for the upper and the other one for the lower jaw) and insert them during implementation one after another, which leads to double the expenditure of time.

Furthermore, when using ready-made teeth, there is the problem that due to the non-personalized tooth length of the ready-made teeth, disturbing contacts occur on the occlusal surfaces, which disturbing contacts, although they are depicted and displayed in the virtual articulator in the software, cannot be taken account of when finishing the prosthesis. A practicable solution for this problem, without transferring the dental replacement manufactured into an articulator, has not been known so far.

If the adhesive bonds of the artificial teeth to the prosthesis base are not firm enough, there is, moreover, the danger, during the masticatory movement or other movements of the teeth inside the mouth, that the teeth are not held inside the cavity of the prosthesis base in a sufficiently stable fashion, and might possibly even fall out of the prosthesis base.

Therefore, the invention is based on the task of creating a dental transfer template arrangement in accordance with the preamble of Claim 1, which reduces the time expenditure during the production of prostheses for both jaws, avoids disturbing contacts on the occlusal surfaces if ready-made teeth are used, and can guarantee a safe adhesive bond of the dental replacement to the prosthesis base.

This task is solved, in accordance with the invention, by Claim 1. Advantageous further embodiments result from the subordinate Claims.

In accordance with the invention, it is intended that a bite barrier of the transfer template, which barrier prevents closure of rows of teeth, is provided in the occlusal plane, the thickness of which barrier measures in particular about 2 to 8 mm, and that, starting from the bite barrier, the tooth recesses are open in mutually opposite directions corresponding to upper jaw and lower jaw.

The bite barrier divides the transfer template in accordance with the invention each in one upper-jaw portion and one lower-jaw portion, which template makes possible at the same time for both jaws the transfer of the teeth, the positioning of the teeth inside the cavity of the prosthesis base.

In accordance with the invention, it is further intended that the transfer template can only be used for either the upper or the lower jaw.

Further, surprisingly in accordance with the invention this bite barrier stiffens the transfer template if the transfer template is used at the same time for the teeth at the upper and lower jaws.

Since ready-made teeth are held inside the recesses of the transfer template, in accordance with the invention it is furthermore possible to use the transfer template for the teeth at both jaws for the purpose of basally shortening the teeth.

Moreover, in accordance with the invention a safe adhesive bonding of each tooth inside the prosthesis base is guaranteed. The adhesive surface of each tooth in the prosthesis base is in accordance with the invention provided with a predefined minimum threshold value, in particular at least 10 mm², preferably at least 18 mm², and particularly preferably at least 25 mm², which threshold value is in particular set in the CAD software of the CAD/CAM device for the production of the prosthesis base. This value can also be increased—depending on the glue—, for instance to at least 39 mm².

In an advantageous embodiment, it is intended that in their size and position, the recesses of the transfer template correspond to the alignment of the rows of teeth in the upper jaw and lower jaw.

In an advantageous embodiment, it is intended that the transfer template has been created in its template shape with recesses for teeth by means of rapid prototyping or by means of milling. The inside surfaces of the recesses in the transfer template which correspond to the occlusal/incisor outside surfaces of the teeth have been created based on a tooth library, which outside surfaces are stored in the CAD/CAM device corresponding to in particular pre-fabricated teeth.

In an advantageous embodiment, it is intended that the transfer template has been manufactured out of a material which is not stiff and which is flexible compared with the teeth, in particular out of a plastics material, such that the teeth can be held inside the recesses of the transfer template at the inside surfaces of the recesses of the transfer template with the help of a limited deformation force and can be transferred into the prosthesis base.

In an advantageous embodiment, it is intended that the transfer template has been manufactured out of suitable materials, in particular out of metal or plastics material, preferably for a better control of the positioned teeth out of a transparent plastics material.

In an advantageous embodiment, it is intended that when calculating the areas of extensions in the transfer template a factor of shrinkage of the ready-made teeth of approximately ±100 m which is due to production factors is taken account of, which factor corresponds to the degree of shrinkage of the ready-made teeth due to thermal expansion.

In an advantageous embodiment, it is intended that the altitude of the teeth in the transfer template is set based on CAD and scanned data and is therefore indirectly set to patient data.

If ready-made teeth are used, due to the non-personalized tooth length, some teeth will protrude over the basal side of the prosthesis base. In accordance with the invention, regions of a tooth penetrating the prosthesis base, the height of which tooth is larger than the altitudinal extension of transfer template and prosthesis base in a state in which said are placed on top of one another, can be ground in such a fashion that they are essentially flush with surrounding surfaces.

In an advantageous embodiment, it is intended that the transfer template is provided with tooth recesses which have been created with the help of the CAD/CAM device and which thus determine a position of the tooth in space, wherein each tooth is held by the transfer template in particular by 5% to 90% of its longitudinal extension.

In an advantageous embodiment, it is intended that the transfer template and the prosthesis base in the assembled state leave some free space surrounding the teeth, the height of which free space amounts to in particular partly 0% to 50%, preferably approximately 20% of the height of the teeth.

In an advantageous embodiment, it is intended that the transfer template and the prosthesis base in the state placed on top of one another are supported at one another over a number, in particular three support locations, and have been brought into a defined relative position with inserted teeth.

In an advantageous embodiment, it is intended that the transfer template together with the prosthesis base firmly bears inserted teeth in all three directions in space, and in this state, in accordance with the invention, region of the teeth which possibly extend beyond the basal side of the prosthesis base can be ground or milled off without any additional and separate supportive contacts for the individual teeth.

In an advantageous embodiment, it is intended that the threshold value of the adhesive surface of the teeth at the prosthesis base is different for different types of teeth—incisors, premolars and molars—and for the corresponding adaptation, an enlargement of the adhesive surface with the help of the CAD software of the CAD/CAM device is requested.

In an advantageous embodiment, it is intended that the threshold value of the adhesive surface of the teeth at the prosthesis base is different for different teeth, in particular for ready-made teeth of different teeth lengths, and for the corresponding adaptation, an enlargement of the adhesive surface with the help of the CAD software of the CAD/CAM device is requested.

In an advantageous embodiment, it is intended that for enlarging the adhesive surface of the teeth at the prosthesis base, the cervical area of the recesses of the prosthesis base may extend into the incisal direction with the help of the CAD/CAM device.

In an advantageous embodiment, it is intended the CAD/CAM device takes into account, when the altitude of the teeth inside the recesses in the prosthesis base is set, an adhesive gap there, in accordance with the invention, of a predefined thickness, in particular partly 0 m to 500 m, preferably 50 m to 250 m, i.e. that the outside shape around this gap is provided to be larger than the cervical area of the teeth and thus the altitude of each tooth is precisely set.

In an advantageous embodiment, it is intended that on the vestibular side at each tooth, window recesses are arranged in order to control the correct altitude of the teeth in the inside surfaces of the recesses in the transfer template.

In an advantageous embodiment, it is intended that with the help of the transfer template, the relative three-dimensional position of upper-jaw and lower-jaw prostheses are fixed, such that the finished prostheses can be brought into an articulator/occludator which can be displaced around the vertical axis, in order to perform an occlusal correction at the prosthesis teeth.

Such an articulator is able to simulate the sequences of movements of the human jaw. The mandibular joint as such moves according the principle of a door hinge during a lowering of the bite situation or an elevation of said, i.e. an elevation in the anterior region of 3 mm corresponds to said in the mastication region approximately ⅓ to 1 mm.

The joint geometry differs depending on the type of articulator. In order to make possible this multitude of joint geometries, the vertical lowering is performed in the same fashion for all articulators. The adapter inside the articulator is equal for the joint geometry. As a result, the joint geometry remains untouched.

With the help of this adapter inside the articulator, the rows of teeth of the upper and lower prostheses are brought into contact, i.e. into occlusion. As a result of this possibility, the centrical position of the rows of teeth of the upper and lower jaws can be examined, re-adjusted by means of grinding technology if necessary. In the case of functional retouchings, the dynamic adjustment and the selective grinding-in can be performed specifically inside the articulator. For this purpose, depending on the type of articulator, at least the slant of the joint and the Benett angle are then adjusted as the minimum requirements.

In an advantageous embodiment, it is intended that the transfer template is re-usable.

In an advantageous embodiment, it is intended that in particular with the help of the CAD/CAM device, a distance between tooth positions for upper-aw and lower-jaw prostheses can be set which is correlated with the vertical axis of displacement of the articulator/occludator.

Further advantages, details and features result from the subsequent description of an exemplary embodiment with the help of the drawings which show:

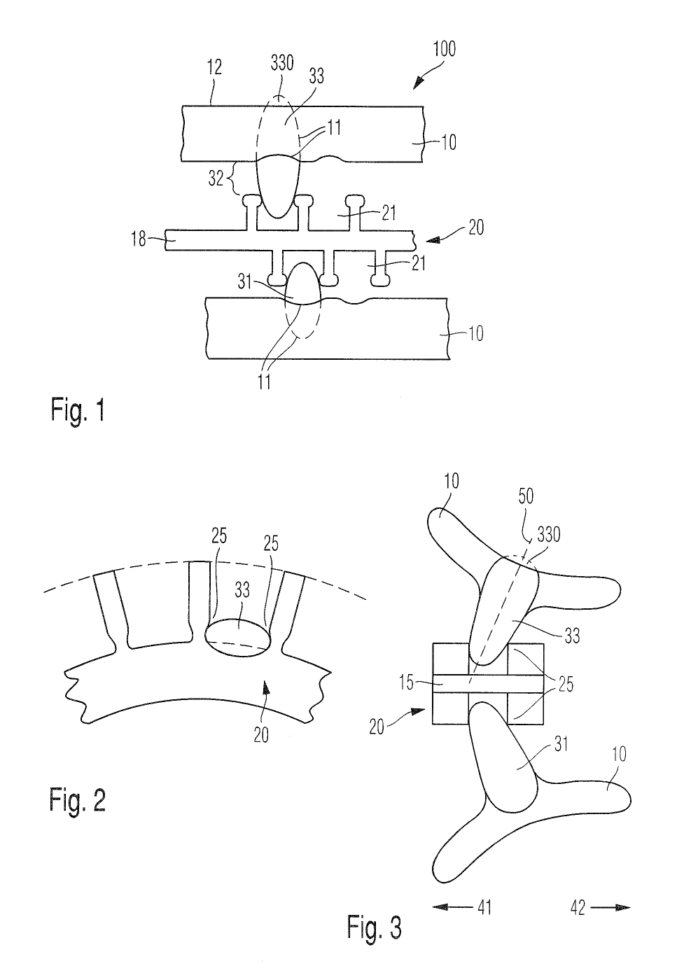

FIG. 1 a schematically depicted embodiment of the dental transfer template arrangement in accordance with the invention in a front view;

FIG. 2 the embodiment of the dental transfer template arrangement in accordance with FIG. 1 in a top view (depicted without prosthesis base);

FIG. 3 the embodiment of the dental transfer template arrangement in accordance with FIG. 1 in a side view;

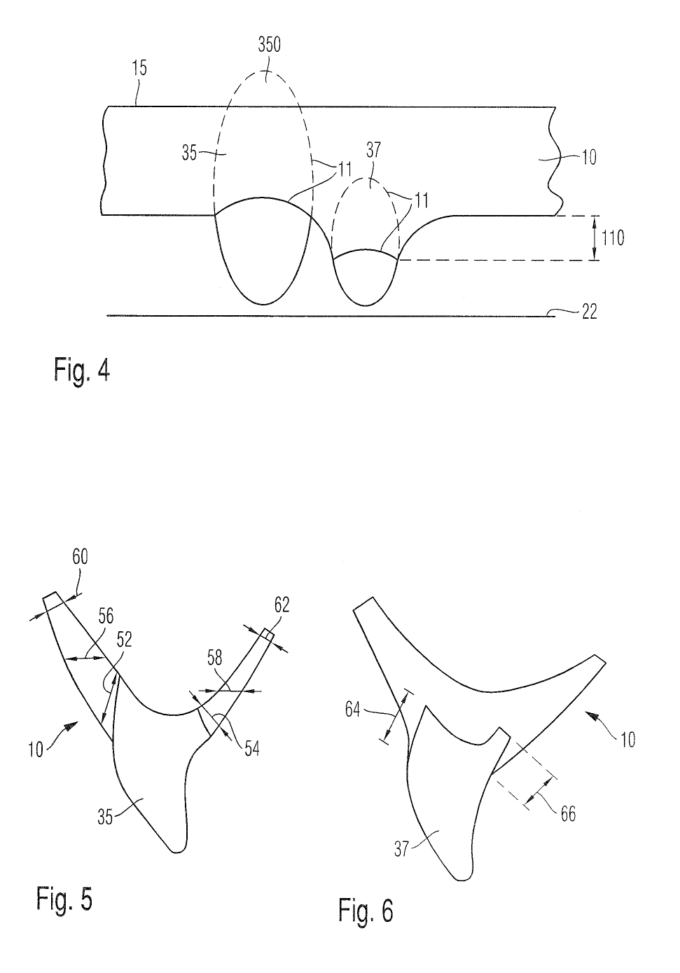

FIG. 4 another embodiment of the dental transfer template arrangement (depicted without transfer template);

FIG. 5 the embodiment in accordance with FIG. 4 in a side view;

FIG. 6 the embodiment in accordance with FIG. 4 in a side view;

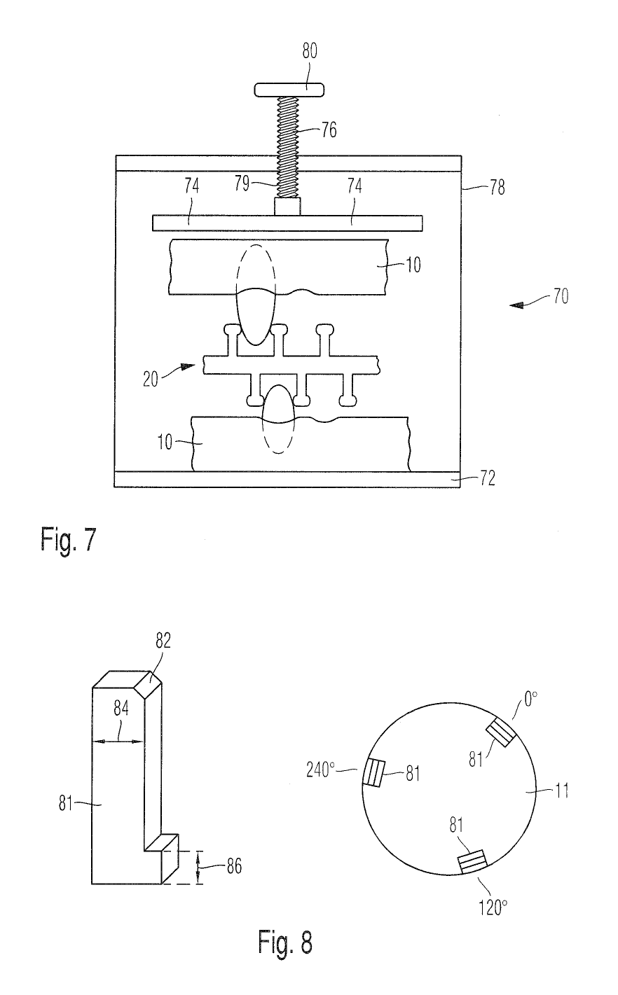

FIG. 7 the holding device and an embodiment of the dental transfer template arrangement;

FIG. 8 the distance holder and its arrangement inside the cavity of the prosthesis base; and

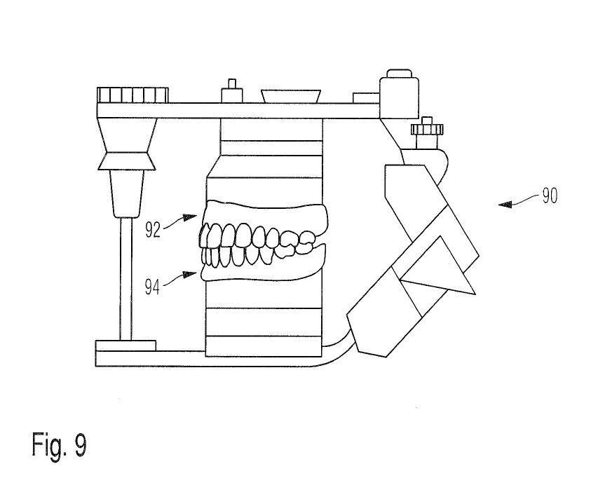

FIG. 9 a schematically depicted articulator with prostheses.

The dental transfer template arrangement 100 depicted in FIG. 1 is provided with a transfer template 20 and two prosthesis bases 10, each for the upper and lower jaws, wherein the transfer template and the prosthesis bases are provided with a large number of the recesses 21 and 11 for incisors, of which incisors 31 and 33 are depicted in FIG. 1. Into transfer template recesses 21 fit incisor and/or occlusal areas and into prosthesis base recesses 11 fit cervical areas of teeth 31 and 33. Incisors 31 and 33 are each to be adhesively bonded into prosthesis base recesses 11.

Transfer template 20 is provided, in accordance with the invention, with a bite barrier 18 which prevents closure of rows of teeth in the occlusal plane, and the thickness of which barrier measures in particular about 1.5 to 8 mm.

This bite barrier 18 divides transfer template 20 each in one upper-jaw portion and one lower-jaw portion and stiffens transfer template 20 if transfer template 20 is used for the teeth at the upper and lower jaws, as is depicted in FIG. 1, at the same time.

Tooth recesses 21 are open, starting from bite barrier 18, in mutually opposite directions corresponding to upper jaw and lower jaw.

Teeth 31 and 33 are introduced into the cavities/recesses 11 of prosthesis bases 10 with the help of transfer template 20 in any suitable fashion in that teeth 31 and 33 are, for instance, temporarily secured in the inside surfaces of recesses 21 of transfer template 20 with the help of wax, resin, or another glue, or teeth 31 and 33 are held inside transfer template 20 by the inside surfaces of recesses 21 of the transfer template with the help of the deformation force. Preferably, transfer template 20 is manufactured out of a transparent plastics material for a better control of the positioned teeth.

Subsequently, teeth 31 and 33 are each positioned into and adhesively bonded into prosthesis bases 10 with the help of transfer template 20.

At the vestibular side of teeth 31 and 33, window recesses of transfer template 20 are arranged in accordance with the invention, in order to control the correct altitude of teeth 31 and 33 in the inside surfaces of recesses 21 in transfer template 20.

Region 330 of tooth 33 which penetrates the basal side 12 of prosthesis base 10 is removed in an essentially flush fashion, in particular it is ground to size or milled off.

In the embodiment in accordance with FIG. 1, recesses 21 of transfer template 20 determine the position of teeth 31 and 33 in space in such a fashion that each tooth is held by transfer template 20 by approximately 30%. In another embodiment, this value amounts to 5% to 90%.

Transfer template 20 depicted in FIG. 1 is joined with prosthesis bases 10 in such a fashion that transfer template 20 surrounding teeth 31 and 33 is in no physical contact with prosthesis bases 10. A free space 32 which surrounds teeth 31 and 33 and whose height amounts to in particular approximately 20% of the tooth length is provided.

In another embodiment (not depicted), the transfer template and the prosthesis bases in the state placed on top of one another are supported at one another over a number, in particular three support locations, and have been brought into a defined relative position with inserted teeth.

In FIG. 2, a transfer template 20 in accordance with the invention with held tooth 33 is depicted according to FIG. 1 in a top view. From the connection of FIGS. 2 and 3 it can be taken that tooth 33 is provided with at least three support locations 25 at transfer template 20 so that tooth 33 can be secured inside the recesses 21 of transfer template 20.

In a preferred embodiment, teeth 31 and 33 are firmly borne, with the help of the deformation force, by support locations 25 of the inside surfaces of the recesses 21 of transfer template 20 in all three directions in space.

In FIG. 3, a dental transfer template arrangement 100 in accordance with the invention is depicted according to FIG. 1 in a side view. Arrows 41 and 42 point into the labial and lingual directions. In the embodiment depicted in FIG. 3, an angle between the vertical axis and root axis 50 amounts to approximately 10° to 35°.

A further embodiment in accordance with the invention is depicted in FIG. 4. It can be seen that the height of the (ready-made) tooth 35 there is comparatively too large for prosthesis base 10. If tooth 35 is adhesively bonded inside the cavity of prosthesis base 10 without any further processing, a strong disturbing contact in the occlusal plane will then be created. Moreover, there is the danger that in the masticatory movement, tooth 35 is held in the cavity of prosthesis base 10 in an instable fashion and might even fall out of prosthesis base 10, which is due to the too small adhesive surface of tooth 35 at prosthesis base 10 proportionally with the areal extent of tooth 35 on a vertical plane. In accordance with the leverage, the load arm corresponding to the adhesive force is for example shorter than the force arm corresponding to the frictional force during the masticatory movement.

In accordance with the invention, it is favourable that tooth 35 can be secured in prosthesis base 10 with the help of transfer template 20 (not depicted) labially downwards until occlusal plane 22 in order to avoid the disturbing contact, as is depicted in FIG. 4. Due to the larger length of tooth 35, tooth 35 penetrates the basal surface 15 of prosthesis base 10. As a result, the adhesive surface is increased. Penetrating region 350 is then ground to size in accordance with the invention. Consequently, the ratio of load arm and force arm is improved and therefore a safe adhesive bond is guaranteed.

In accordance with FIG. 4, a tooth 37 is further provided whose height is comparatively too small for prosthesis base 10. If tooth 37 is adhesively bonded into the cavity of prosthesis base 10 in a manner known per se, also due to the leverage during the process of chewing the adhesive surface is too small, as is the case with tooth 35 mentioned above, to guarantee a safe adhesive bond.

In accordance with the invention, it is particularly favourable that the CAD software for the production of the prosthesis base warns of the danger that no sufficient adhesive surface is available.

In accordance with the invention, it is further favourable that cavity 11 of prosthesis base 10 is transformed, under the control by the CAD/CAM device, in such a fashion that the cervical area of cavity 11 extends into the incisor direction. The extensional dimensioning is referred to as height 110 in FIG. 4. The elongated cavity 11 of prosthesis base 10 depicted in FIG. 4 makes possible, in accordance with the invention, an additional adhesive surface of tooth 37 at prosthesis base 10. As a result, a safe adhesive joint is guaranteed.

In FIG. 5 and FIG. 6, teeth 35 and 37 are depicted in a side view.

The thickness of the collar region of prosthesis base 10 at the cervical edge of teeth 35 and 37 labially 56 (or buccally, respectively) and palatinally 58 (or lingually, respectively) must amount to more than 2 mm.

The thickness at the minimally highest point (2 mm) of collar region 60 and 62 must always amount to more than 0.5 mm. After that, the thickness can be tapering off.

In accordance with the invention, it is favourable that the threshold values with reference to the minimum requirements of the adhesive bonding can be adjusted in the CAD software, wherein two cases are explained by way of examples here:

Case 1—Adhesive bonding without or partly with basal contact to prosthesis base 10 corresponding to tooth 35 in accordance with FIG. 5:

minimum height of collar region 52 and 54 of prosthesis base 10 must amount to more than 2 mm, over 360° roundabout;

Case 2—Adhesive bonding with full basal contact to prosthesis base 10 corresponding to tooth 37 in accordance with FIG. 6:

minimum height of collar region 64 and 66 of prosthesis base 10 must amount to more than 2 mm, over 180° roundabout, preferably labially and palatinally (or buccally and lingually, respectively) including, and the minimum height of the collar region of prosthesis base 10 for the remaining 180° must amount to more than 1 mm.

In case 1, optimum collar height should amount to more than 3 mm, wherein a bulge or a jacket is provided which is an elongation of cavity 11 of prosthesis base 10 in FIG. 4, wherein at least 50% of the jacket is preferably placed in the lingual or palatinal area, respectively.

In accordance with the invention, it is further favourable that based on the above threshold values the minimum adhesive surface which guarantees a safe adhesive bonding of the tooth at the prosthesis base can be calculated and is in particular set in the CAD software for the production of prosthesis base 10.

If the currently smallest tooth shape A3 of the Applicant without basal depression is made reference to, the circumference of tooth A3 measured in the centre of the collar height amounts to 14.6 mm and the bottom surface of tooth A3 to 16.97 mm² (the subsequent algorithm can also be used with alternative tooth shapes of different sizes or from different companies).

In Case 1 mentioned above, which is adhesive bonding without or partly with basal contact to the prosthesis base, a minimum adhesive surface results of 14.6 mm×2 mm=29.2 mm².

In Case 2 mentioned above, which is adhesive bonding with full basal contact to the prosthesis base, the entire adhesive surface should be calculated from the combination of collar surface and basal surface, wherein the minimum adhesive surface results in this fashion:
collar surface over 180° with 2 mm height=14.6 mm/2×2 mm=14.6 mm²;
collar surface over 180° with 1 mm height=14.6 mm/2×1 mm=7.3 mm²;
basal surface with full basal contact to prosthesis base=16.97 mm²;
minimum adhesive surface=14.6 mm²+7.3 mm²+16.97 mm²=38.87 mm².

In accordance with the Moffit bond test (lever-out test), for the teeth with the minimum adhesive surfaces mentioned above, there results a breaking load of around 500 N. Herein, it is favourable to perform immediately before the adhesive bonding a roughening, preferably by means of sand-blasting with aluminium oxide particles of a grain size of 100 m and a pressure of 1 to 2 bar. It can further be of advantage to pre-moisten the adhesive surfaces, for instance with ProBase cold Monomer of the present Applicant, in particular if composite teeth are used with which the cutting surface bios reaches into the cervical area.

In FIG. 7, a holding device 70 for the lower-jaw and/or upper-jaw prosthesis is depicted, which device can support/secure the fixation of the teeth at prosthesis bases 10 or the hardening of the glue.

Holding device 70 is provided with a substrate 72, a frame 78, at least three beams 74 (only two of those depicted in FIG. 7), a punch 79 with thread 76 and a turning handle 80.

Prosthesis bases 10 together with the teeth in the cavities of said and with transfer template 20 can be applied onto substrate 72 of holding device 70 and can be fixed there.

Beams 74 can be raised and lowered by means of turning turning handle 80 in the vertical direction over punch 79. If, in accordance with FIG. 7, beams 74 are lowered downwards until the upper side of upper prosthesis base 10 and even further, a pressure is exerted by beam 74 in a downward direction over this prosthesis base 10 onto the teeth, transfer template 20 and lower prosthesis base 10.

Both prosthesis bases 10 are then clamped by beam 74 and substrate 72 of holding device 70, and in this fashion, a fixation of the teeth at prosthesis bases 10 and a hardening of the glue are supported. A central arrangement of punch 79 results in a uniform holding force.

In accordance with the invention, it is further favourable that in the CAD software, the adhesive gap between teeth and prosthesis base is defined with 100 m. If in the positioning and adhesive bonding, the teeth is to be more precisely centred into the cavities of prosthesis bases 10, and it is desired that the adhesive gap of 100 m be secured around the teeth, favourably in accordance with the invention at least three spacers 81, as depicted in FIG. 8, are used. Without the spacers, the adhesive gap amounted to between 78 and 160 m, with said, the fluctuation in width was not measurable.

Tooth recess 11 in prosthesis base 10 is depicted in a top view in accordance with FIG. 8. The three spacers 81 are arranged at the inside surface of the approximately circular tooth recess 11 spaced apart from each other by 120° protruding inwards extending vertically to the horizontal plane.

Upper part 82 of spacers 81 is angled for an easier insertion of the teeth into cavity 11 of prosthesis bas 10. The lateral distance and the basal distance between teeth and the cavity of prosthesis base 10, which distances are made possible as an adhesive gap with the help of spacers 81, each correspond to length 84 and height 86, which amount to 100 m each.

In FIG. 9, an articulator 90 with prostheses is depicted schematically. The finished prostheses with upper-jaw portion 92 and lower-jaw portion 94 are inserted into that articulator which is displaceable around the vertical axis, in order to perform an occlusal correction at the teeth of the prosthesis.

1. Dental transfer template arrangement, comprising a transfer template and a prosthesis base which are both produced by the same CAD/CAM device,
wherein both the transfer template and the prosthesis base have a large number of recesses for teeth, wherein incisor and/or occlusal areas fit into the recesses of the transfer template and cervical areas of teeth fit into the recesses of the prosthesis base,
wherein the teeth are each to be adhesively bonded in the recesses of the prosthesis base, characterized in that
a bite barrier (18) of the transfer template (20), which barrier prevents closure of rows of teeth, is provided in the occlusal plane, a thickness of the barrier measures about 2 to 8 mm, and
starting from the bite barrier (18), the tooth recesses (21) are open in mutually opposite directions corresponding to upper jaw and lower jaw.
teeth are held in the recesses (21) of the transfer template (20) and the transfer template (20) for the teeth (33, 35) can be used for basal shortening of the teeth, and
the adhesive surface of each tooth (31, 33, 35, 37) in the prosthesis base (10) has a predefined minimum threshold value, which threshold value is set in the CAD software of the CAD/CAM device for the production of the prosthesis base.

2. Transfer template arrangement in accordance with claim 1, characterized in that
the bite barrier (18) is arranged along a vestibular side of the transfer template (20) horizontally at the teeth (31, 33, 35, 37) to be held and approximately at medium height of the transfer template (20), and
the bite barrier (18) stiffens the transfer template (20) if the transfer template (20) is used for the teeth (31, 33, 35 37) at the upper and lower jaws at the same time, and
the bite barrier (18) divides the transfer template (20) each in one upper-jaw portion and one lower-jaw portion.

3. Transfer template arrangement in accordance with claim 2, characterized in that the CAD/CAM device creates the transfer template (20) based on scanned and CAD data in which both scanned and CAD data are each obtained from a three-dimensional scan of an oral situation of a patient and from a template library in the CAD software and the CAD/CAM device creates the prosthesis base (10) based on the same scanned data and the CAD data from a prosthesis base library in the CAD software, and that cervical areas of teeth can each, using the transfer template (20), be introduced into the prosthesis base tooth recesses (11) and can be adhesively bonded thereto the prosthesis base.

4. Transfer template arrangement in accordance with claim 3, characterized in that the transfer template (20) has been created in a template shape with recesses (21) for teeth (31, 33, 35, 37) suited to a dental replacement of a prosthesis base (10), by means of rapid prototyping or by means of milling, and that the inside surfaces of the recesses (21) in the transfer template (20) which correspond to the occlusal/incisor outside surfaces of the teeth (31, 33, 35, 37) have been created based on a tooth library, wherein outside surfaces have been stored in the CAD/CAM device in accordance with pre-fabricated teeth.

5. Transfer template arrangement in accordance with claim 4, characterized in that the threshold value is different for different types of teeth comprising—incisors, cuspids, premolars and molars—and for the corresponding adaptation of the prosthesis base (10), an enlargement of the adhesive surface with the help of the CAD software of the CAD/CAM device can be requested.

6. Transfer template arrangement in accordance with claim 1, characterized in that the threshold value is different for different teeth comprising ready-made teeth of different teeth lengths, and for the corresponding adaptation of the prosthesis base (10), an enlargement of the adhesive surface with the help of the CAD software of the CAD/CAM device can be requested.

7. Transfer template arrangement in accordance with claim 5, characterized in that for enlarging the adhesive surface, the cervical area of the recesses (11) of the prosthesis base (10) can be extended in the incisor/occlusal direction with the help of the CAD/CAM device.

8. Transfer template arrangement in accordance with claim 7, characterized in that when calculating areas of extensions in the transfer template (20) a factor of shrinkage of the teeth, which is due to production factors, is taken account of, which factor displays the degree of shrinkage of the teeth (31, 33, 35, 37).

9. Transfer template arrangement in accordance with claim 8, characterized in that altitude of the teeth (31, 33, 35, 37) in the transfer template (20) is determined based on CAD and scanned data, and indirectly to patient data and that areas of a tooth (31, 33, 35, 37) penetrating the prosthesis base (10), the height of which tooth is larger than the altitudinal extension of transfer templates (20) and prosthesis base (10) and in a state in which the transfer templates and prosthesis are placed on top of one another, the teeth which are larger than the altitudinal extension can be ground in such a fashion that they are essentially flush with surrounding surfaces.

10. Transfer template arrangement in accordance with claim 9, characterized in that the transfer template (20) is provided with tooth recesses (21) which have been created with the help of the CAD/CAM device and which determine a position of the tooth (31, 33) in space, wherein each tooth (31, 33) is held with a share of a longitudinal extension by the transfer template (20).

11. Transfer template arrangement in accordance with claim 10, characterized in that the transfer template (20) and the prosthesis base (10) in the assembled state leave some free space (32) surrounding the teeth (31, 33), the height of which free space corresponds to a share of the height of the teeth (31, 33).

12. Transfer template arrangement in accordance with claim 11, characterized in that the transfer template (20) and the prosthesis base (10) in the state placed on top of one another are supported by one another over a number of support locations, and are diposed in a defined relative position with inserted teeth (31, 33).

13. Transfer template arrangement in accordance with claim 12, characterized in that the transfer template (20) together with the prosthesis base (10) firmly bears inserted teeth in all three directions in space, and that the basal areas of the teeth (31, 33) which penetrate the prosthesis base can be ground or milled off without any additional and separate supportive contacts for the individual teeth (31, 33).

14. Transfer template arrangement in accordance with claim 13, characterized in that the CAD/CAM device takes into account, when the altitude of the teeth inside the recesses (11) of the prosthesis base is determined, an adhesive gap of a predefined thickness and that the outside shape around this gap is provided to be larger than the cervical area of the teeth and the altitude of each tooth is precisely set.

15. Transfer template arrangement in accordance with claim 14, characterized in that on the vestibular side at each tooth, window recesses of the transfer template are arranged, such that the correct altitude of the teeth can be controlled in the inside surfaces of the recesses (21) in the transfer template (20).

16. Dental transfer template arrangement in accordance with claim 1 wherein the predefined minimum threshold value is at least 10 mm².

17. Dental transfer template arrangement in accordance with claim 1 wherein the predefined minimum threshold value is at least 18 mm².

18. Dental transfer template arrangement in accordance with claim 1 wherein the predefined minimum threshold value is at least 25 mm².

19. Transfer template arrangement in accordance with claim 8, characterized in that the teeth comprise ready-made teeth.

20. Transfer template arrangement in accordance with claim 11, characterized in that the number of support locations comprises three.

21. Transfer template arrangement in accordance with claim 14, wherein the predefined thickness of the adhesive gap is 0 μm to 500 μm.

22. Transfer template arrangement in accordance with claim 14, wherein the predefined thickness of the adhesive gap is 50 μm to 250 μm.
